(19) United States
(12) Patent Application Publication
(10) Pub. No.: US 2018/0186494 A1
(43) Pub. Date: Jul. 5, 2018

(54) APPARATUS AND METHOD FOR LABELING CONTAINERS

(71) Applicant: KRONES AG, Neutraubling (DE)

(72) Inventor: Volker KRONSEDER, Neutraubling (DE)

(21) Appl. No.: 15/738,535

(22) PCT Filed: Apr. 11, 2016
(86) PCT No.: PCT/EP2016/057906

§ 371 Date: Dec. 20, 2017

(30) Foreign Application Priority Data
Jun. 30, 2015 (DE) 10 2015 212 140.2

(51) Int. Cl. B65C 9/22; B65C 9/14; B05D 5/10; B05D 1/26; B05C 5/02; B05C 13/02

(52) U.S. Cl. CPC B65C 9/2217; B65C 9/14; B05D 5/10; B65C 2009/0059; B05C 5/0212; B05C 13/02; B05D 1/26

(57) ABSTRACT

The present invention relates to an apparatus and a method for preparing labels for application to containers, wherein glue is applied in a variable glue image directly onto a glue application surface of at least one label by means of a controllable glue printer.

### FIELD OF THE INVENTION

The present invention relates to an apparatus and a method for applying glue to labels of different shapes and sizes and for applying these labels to containers or packs.

### PRIOR ART

Labeling machines are used in industry to apply, continuously and with high performance, labels to continuously fed articles, containers or packs of containers. The containers may be glass bottles, plastic bottles, in particular PET bottles, cans or can-like containers or the like, which are filled with liquid or solid foodstuff, medical or cosmetic products, hygiene products or the like. The labeling machines normally comprise an often modular labeling unit.

Such labeling units for labeling machines, in particular also for circulating-type labeling machines, for applying labels, in particular also paper labels, to bottles or similar containers making use of cold glue are known in the prior art. Such units comprise as a matter of principle at least one pallet carrier or glue segment carrier, which is adapted to be driven for circulation around a vertical axis of the unit and which is also referred to as pallet carousel, having provided thereon a plurality of label pallets or glue segments respectively defining at least one label reception or contacting surface. The pallets or glue segments are configured such that they are pivotable in a controlled manner about a pivot axle of their own. During the labeling process, the pallets or glue segments are, in the course of each circulation of the glue segment carrier, first moved past a glue application station for producing a glue coat on their label contacting surface, whereupon they are moved past a label dispensing station from which a respective label is taken over, which then adheres with its back to a label contacting surface provided with the glue coat, whereby glue will simultaneously be applied to the back of the label. Via a gripper cylinder, the respective glue-coated labels are transferred to the containers that are moved past the labeling unit.

The application of glue to the glue segments or to the label contacting surfaces thereof takes place at the glue application station of conventional labeling units via a rotationally driven glue roller whose circular cylindrical circumferential surface has a glue film applied thereto by means of a glue application bar. Such glue rollers have a complex structural design and they are expensive. Furthermore, they are subjected to high wear and they also cause substantial contamination of the labeling unit as well as of the labeling machine by splashing glue.

EP 2 111 359 B1 describes a labeling unit for use in labeling machines for labeling bottles or similar containers with labels using cold glue, comprising at least one glue segment, which can be driven such that it circulates about an axis of the unit and at the same time can also be pivoted in a controlled manner about a pivot axle that is radially displaced in relation to the axis of the unit, said glue segment forming a label contacting surface. A gluing station as well as at least one label dispensing station configured for dispensing the labels to the respective passing label contacting surface are arranged on the circulatory path of the label contacting surface of the at least one glue segment, the gluing station comprising at least one glue application nozzle on the path of movement of the label contacting surface of the at least one glue segment for directly applying the glue to the respective label contacting surface passing by. The labels are, as usual, taken over from the glue-coated label contacting surface and simultaneously coated with glue. Subsequently, the glue-coated labels are transferred to a gripper cylinder, which transfers them to the bottles.

The labeling unit described is disadvantageous insofar as the glue is applied to the pallet and, subsequently, the labels are removed from the label magazine by the glue-coated pallets, whereby, as is generally known, the glue may be spread and contaminations may be caused. Likewise, the use of the gripper cylinder leads to a complex structural design, which is, moreover, maintenance prone. Furthermore, in the case of irregular label formats, like shoulder labels or champagne bands, a full-area application of glue up to the label edge is, due to the use of the gripper cylinder, not possible for labels by means of the labeling unit described. This may have the effect that the label projects from the bottle after the labeling process. Moreover, after having been applied to the pallet and in the required glue return flow, the glue is exposed to the ambient air, and this may lead to a change of its characteristics.

Therefore, it is the object of the present invention to provide a labeling unit, which is used for labeling containers or packs with labels making use of glue, especially cold glue, and which avoids the above-described drawbacks and, in particular, renders the use of gripper cylinders superfluous. Quite generally, the object underlying the present invention is to reduce the installation and maintenance effort of the labeling machine and to save costs. Moreover, labels of arbitrary shape are to be reliably processed.

### DESCRIPTION OF THE INVENTION

The above-mentioned objects are achieved by a method for preparing labels for application to containers, wherein cold glue is applied in a variable glue image directly onto a glue application surface of at least one label by means of a controllable glue printer.

The containers may be cans, glass bottles, plastic bottles or the like. The labels to be applied may be wrap-around labels or front and rear labels. In addition, shoulder labels and body labels for bottles may be used. The labels may be made of paper, a plastic foil or the like. However, according to the present invention the labels normally have neither any pre-applied glue coat, e.g. after the fashion of an activatable adhesive, nor are they self-adhesive. The labels are, however, prepared for application, i.e. for gluing them onto the containers to be labeled, according to the above-mentioned method by applying cold glue to their glue application surface. A label normally has an image side, on which the information to be presented is shown, and a back. The glue application surface of the label may comprise the whole area of the label back or only part of the same. In addition, the glue application surface need not necessarily be a continuous surface, but may be defined e.g. by separate areas for leading-edge and trailing-edge glue coating of a label. Also complex glue coat patterns and arrangements of glue application surfaces are imaginable, as will be described hereinafter.

According to the present invention, glue, in particular cold glue is applied in a variable glue image by means of a controllable glue printer directly onto a glue application surface of the labels. The glue used may be highly fluid glues, glues having a viscosity between 600 and 80,000 mPas and casein or dispersion glues with an optimum processing temperature between 18° C. and 40° C. In addition to cold glue application, also hot glue may be applied to subareas of the glue application surface of the label, the glue printer being then suitably configured e.g. by providing a heating device. A glue image means here and in the following a glue application pattern which is applied to the glue application surface. The glue application pattern may consist of an arbitrary two-dimensional distribution of glue dots, glue lines and/or glue areas. When cold glue is used, it will especially not be absolutely necessary to apply glue to the labels over large areas thereof, since glue dots or glue lines applied to the glue application surface will spread when the label is being pressed onto the container surface and will thus be able to merge into one another. In addition, it will also be possible to provide only parts of the glue application surface with glue, e.g. a marginal area or a leading-edge and a trailing-edge area, so as to accomplish a sufficient hold of the label on the container surface.

By using a controllable glue printer, the printed-on glue image can be varied in accordance with the present invention. To this end, the glue printer may have one or a plurality of controllable glue nozzles by means of which the glue is sprayed, under pressure, onto the glue application surface dropwise or as a continuous jet. The control of the glue printer may here comprise the control of said one or said plurality of glue nozzles with respect to the discharge of glue and/or the orientation of the glue nozzles and of the glue printer in its entirety. The application of glue may e.g. also be executed in a single-jet process by two-dimensionally moving the glue nozzle and/or the label relative to one another. The control of the glue printer may thus comprise the control of the glue nozzles and the control of this movement. It goes without saying that this will also apply if a multi-jet glue printer is used. In addition, the glue printer may apply the glue image onto the glue application surface in particular according to the ink-jet method. Application by means of a continuous jet as well as according to the DoD principle (drop-on-demand) is possible. According to the present invention, the glue is applied directly onto the glue application surface of the label and, consequently, especially not via a glue segment, as has been described in the prior art. This facilitates, on the one hand, the control of glue application, in particular for irregularly shaped labels, such as champagne bands, or irregular glue images, since direct application to the label via a controllable glue printer can be executed with much higher precision than the preparatory application to a glue segment surface onto which the glue application side of the label to be coated with glue will then have to be placed in an adequately precise manner. In addition, the otherwise necessary turning of the label to a position at which the glue side is exposed, which is normally executed by means of a gripper cylinder, can be dispensed with, since the glue side is already exposed due to the direct application of glue. Hence, it will also be possible to avoid uncoated areas of the glue image, which are caused e.g. by the gripper fingers of the gripper cylinder, whereby it can be guaranteed that the label will reliably adhere to the container. By directly applying the glue, the labels can be coated with glue up to the label edge, a circumstance which is particularly advantageous in the case of champagne bands or shoulder labels. Glue application by means of a controllable glue printer will additionally reduce the cleaning effort to a substantial extent.

According to a further development, the method may additionally comprise the individual or groupwise control of a plurality of glue nozzles of the glue printer in such a way that a desired glue image is applied to the glue application surface of the label. As has already been mentioned, the glue nozzles may here operate in particular according to the ink-jet principle, where one or a plurality of glue nozzle rows oriented perpendicular to the direction of movement of the glue application surface is/are accurately activated so as to accomplish a desired glue image on the glue application surface, i.e. a desired dosage and distribution of the applied glue.

The control of the glue nozzles may here take place analogously to the control of the ink-jet nozzles of an ink-jet printer by means of a suitable open-loop and/or closed-loop control unit. In particular, glue application may be adapted to the shape and the size of the label, so that no glue will be applied outside the label onto the pallets conveying the labels, since this would result in contamination of the pallets. In addition, due to the controlled dosage, the normally provided glue return flow can be dispensed with completely. The application of glue according to the ink-jet principle also has the effect that the glue will not be exposed to unnecessary influences through the ambient air, in particular through the oxygen contained in the latter, so that there will be no change in the glue characteristics. Application can take place in a contact-free manner by choosing the distance between the glue nozzle and the label large enough for allowing glue drops to separate from the nozzle opening as they do in a jet. Depending on the consistency of the glue used, e.g. a distance between 1 mm and 2.5 mm may be chosen. Alternatively, a smaller distance may be chosen, so that the glue will be applied in a contact process, the non-zero distance between the nozzle opening and the label being so small that it will be fully bridged by a glue drop. In this case, the glue nozzles may be configured e.g. as channel nozzles.

By changing the control of the glue nozzles, the applied glue image can be varied almost arbitrarily within the framework of the dimensions of the nozzle array. Thus, a great variety of label sizes and formats, also those of a complex nature, such as e.g. champagne bands, can be processed. Also non-continuous glue images comprising e.g. separate leading-edge and trailing-edge glue coats for body labels can easily be dealt with. If, in addition to the cold glue, also hot glue is to be applied in certain areas, the glue printer may be provided with separate, in particular heatable glue nozzles for this purpose. Alternatively, a heatable valve may be arranged upstream of the glue nozzle. The glue images belonging to specific label formats may be stored, after the fashion of a type management, in a memory unit of the open-loop and/or closed-loop control unit, in particular in a programmable logic control unit, from where they can be retrieved by a processor unit of the open-loop and/or closed-loop control unit for controlling the glue nozzles. Hence, the labeling process can be changed over to a different label format in a rapid and flexible manner.

According to a further development, the method may additionally comprise the step of moving the glue application surface to be printed-on past a plurality of glue discharge openings of the glue printer by means of a pallet which is pivotable in a controlled manner, with the glue application surface facing away from the pallet.

Label pallets are in principle known in the prior art. U.S. Pat. No. 3,736,213, for example, describes a so-called pallet carousel comprising a plurality of pallets which are adapted to be driven such that they circulate around an axis of rotation of the carousel for taking over labels from a label magazine and for conveying the labels that have been taken over. To this end, each of the pallets is configured such that it can be pivoted and/or rotated in a controlled manner about a pivot axle of its own, which is radially displaced relative to the axis of rotation. By controlled pivoting and/or rotation of the pallets, the respective curved contacting surface of the latter is brought into contact with the label to be taken over. In U.S. Pat. No. 3,736,213 the adhesion of the glue applied to the contacting surface of the pallet has the effect that a single label is removed from the label box and conveyed by the pallet. According to the present invention, this application of glue to the pallet does no longer take place. Instead, the label to be taken over can be caused to adhere by configuring the pallets in a suitable manner. To this end, the contacting surface of the pallet may be coated e.g. with a material having sufficiently strong adhesion characteristics or it may be provided with suitable gripper elements, like those of a gripper cylinder. A particularly elegant variant is obtained, when the pallets are configured as vacuum pallets as will be described hereinafter.

The pallets may, like those in U.S. Pat. No. 3,736,213, eccentrically be supported on their pivot axles such that the curved contacting surface of the pallet will roll optimally, i.e. without slipping, on a flat surface, as is e.g. the case with a label box or a linear conveyance of the containers. By increasing the eccentricity of support, it will, however, also be possible to realize optimal rolling on a curved surface, as will be the case e.g. when the containers are conveyed by means of a container table. In addition, the eccentricity of support of the pallet on the pivot axle may be changed, if necessary, e.g. via a controllable linear actuator. For example, the eccentricity in the area of the label box may be smaller than that at the point where the labels are transferred to the containers conveyed along a curved path by a container table, an open-loop and/or closed-loop control unit of the labeling machine controlling the change in the eccentricity of the support of the pallet depending on a position of the pallet along the circulatory path. Alternatively, the eccentricity may be changed automatically by one or a plurality of control cams of the pallet carousel, possibly in cooperation with a resetting-type spring device for the support, while the pallets are circulating around the axis of rotation of the carousel. The control cams may here simultaneously also cause pivoting of the pallets. Alternatively, the pivotal movement and/or rotation of the pallets can be effected by means of one or a plurality of servomotors. Also in this case, control will be executed by a suitable open-loop and/or closed-loop control unit of the labeling machine.

According to the present further development, the label taken over from and conveyed by the pallet is conveyed such that its glue application surface moves past the glue discharge openings of the glue printer, the glue application surface of the label having, at least over part of its area, cold glue applied thereto during this movement. It follows that glue is applied directly and without any intermediate step onto the back of the label. To this end, the label is supported on the pallet such that its image side faces the pallet and its glue application surface thus faces away from the pallet. The label may here move preferably perpendicular to an orientation of the above-mentioned rows of glue nozzles or glue discharge openings. It follows that, in principle, a single row of glue nozzles, which is oriented perpendicular to the direction of movement, will suffice for producing a two-dimensional glue image on the glue application surface. Additional rows may, however, be provided for improving the application of glue and/or for increasing the print resolution. The glue discharge openings may be provided as openings of the glue nozzles or as openings of glue channels. In the case of the latter, glue can be applied in a quasi-contact mode, i.e. the distance between the glue discharge openings and the glue application surface is so small that it will be fully bridged by a glue drop. Glue drops can therefore not separate from the glue discharge openings, so that contamination caused by glue splashes can be avoided.

According to a special further development, the pivotal movement of the pallet can be controlled such that the glue application surface to be printed-on is moved past the glue discharge openings of the glue printer at a constant distance therefrom, in particular at a distance between 1 mm and 2.5 mm. As has already been mentioned, a constant distance can here be made possible by eccentrically supporting the pallet on the pivot axle. When the array of glue nozzles has a non-negligible extension in the direction of movement of the pallet, e.g. when many parallel rows of glue nozzles are provided, the rows may be arranged in a curved area. A constant distance during the printing process has the effect that the glue image will be applied with a constant resolution and the glue will be applied with constant dosage per area element. The amount of glue used can thus be minimized. Due to the fact that the glue is applied in a contact-free mode, the label adhering to the pallet can also be prevented from shifting thereon.

According to a further development, the method may further comprise the step of suctionally attracting the label by means of a plurality of suction openings in a contacting surface of the pallet. In particular, the method may comprise the step of taking the label over from one of the label providing units described hereinafter and conveying the label then by means of the plurality of suction openings of the pallet by negative pressure, i.e. suction. To this end, the pallet is configured as a so-called vacuum pallet having supplied thereto negative pressure via a vacuum system. Vacuum systems are well known in the prior art and will therefore not be described in detail in the present context. The vacuum system may e.g. comprise a controllable vacuum pump and a plurality of vacuum lines, which connect the vacuum pallets to the vacuum pump. It is also imaginable to use a rotary distributor, so as to supply negative pressure to the respective active vacuum pallets. In other words, the negative pressure supply may be configured such that the pallets have negative pressure supplied thereto for taking over and conveying the label and are separated from the negative pressure supply for the purpose of transfer and empty running. The suction openings may be distributed, e.g. in the form of a matrix, over the label contacting surface such that a plurality of different label formats can be taken over from and conveyed by the vacuum pallet. For taking over the label from the label providing unit, the contacting surface of the pallet is moved past the image side of the label provided by the label providing unit for transfer, such that the image side is suctionally attracted by the suction openings. For this purpose, the suction openings may either be brought into mechanical contact with the label or they may be moved past the label at a small distance therefrom, e.g. smaller than or equal to 1 mm. Depending on the size and the material of the label, the negative pressure may be chosen such that the label will be reliably held on the vacuum pallet and will not be stripped off from the vacuum pallet, not even through the glue application process, and not even if glue application takes place through contacting.

According to a special further development, the suction openings may be activated or deactivated, individually or in groups, depending on a size and/or shape of the label to be conveyed. To this end, the suction openings may be provided, e.g. individually or in groups, with controllable control valves, e.g. piezoelectrically operated valves, which are opened and closed by an open-loop and/or closed-loop control unit of the labeling machine in a controlled manner. By opening the valves, the suction openings are activated, i.e. supplied with negative pressure. By closing the valves, the suction openings are deactivated, i.e. separated from the negative pressure supply. According to the present further development, controlled activation takes place depending on the size and/or shape of the label to be taken over. For this purpose, the parameters concerning the size and/or shape may be stored in the open-loop and/or closed-loop control unit after the fashion of a type management, so that an exchange of labels can be executed in a rapid and flexible manner. To this end, the dimensions of the vacuum pallet are such that a plurality of different label formats, such as body labels and shoulder labels, ribbon labels, wrap-around labels, front and rear labels or the like, can be taken over and conveyed. For example, the size of the vacuum pallet may be adapted to the dimensions of the wrap-around labels for the largest containers to be labeled. Also the number of suction openings is adapted to the size of the vacuum pallet. When a lower degree of flexibility is accepted, the suction openings may also be activated and deactivated in groups by supplying the respective groups with negative pressure, e.g. via a common control valve. In this way, the control can be simplified and installation costs can be saved.

Alternatively to the control via control valves, also automatic control through contact with the label to be taken over may be used, as will be described in more detail hereinafter. To this end, the pallet is brought into mechanical contact with the label to be taken over, such that the suction openings contacting the label will be activated, i.e. connected to the negative pressure supply, by the contact itself. This can be accomplished e.g. by the use of touch valves. This will automatically have the effect that only the suction openings which are required for taking over the label will be activated. By suitably controlling the glue nozzles of the glue printer, an application of glue to suction openings that are not occupied by the label will be prevented. The described alternative makes type management for controlling the suction openings superfluous, whereby the plant in its entirety can be simplified.

Provided that the vacuum output is sufficiently high, it will also be possible to do completely without any control of the suction openings. If it is accepted that the suction openings not covered by the transferred label will constantly draw in air, all the suction openings may always be supplied with negative pressure, i.e. remain activated. By way of example, the pallet may be configured with a vacuum pad which consists of a porous material, e.g. a sintered plastic material, and which has negative pressure supplied thereto. This, however, requires a higher vacuum output of the vacuum system used. In order to avoid an excessive increase in the amount of energy required, the suction openings may be distributed in the label contacting surface of the vacuum pallet in accordance with a likelihood of their use. For example, a particularly large number of openings may be provided in an area which will be occupied by the majority of label formats, whereas specific areas for special formats will be equipped with a lesser density of suction openings. Also the size of the openings may be chosen in accordance with this likelihood. Hence, the main burden of suction performance will normally be borne by the frequently used suction openings. The vacuum pallets described can be used in a particularly easy manner. Care should, however, be taken that glue will not be applied to the non-occupied part of the contacting surface, so as to avoid in particular clogging of the non-occupied suction openings. To this end, e.g. the described method for applying a desired glue image, in particular according to the ink-jet method, may be used.

It is also imaginable to retrofit the employed pallets for use with a different label format by attaching or incorporating an accessory, e.g. a hole template, which is adapted to the label format and which blocks the suction openings not required. Finally, it is also imaginable to exchange the vacuum pallets, or at least the vacuum pallet parts comprising the contacting surface, for the purpose of retrofitting for use with a different label format.

According to another further development, the method may additionally comprise the step of releasing the label by deactivating all the suction openings of the pallet. As has been described hereinbefore, the suction openings can be deactivated by separating them individually or in groups from the negative pressure supply, e.g. by means of individually controllable control valves. Alternatively, the whole vacuum pallet may be separated from the negative pressure supply, e.g. by interrupting the vacuum line supplying the pallet, for transferring the glue-coated label. By deactivating the suction openings holding the label, the latter will be released from the vacuum pallet, so that it can be transferred without any major effort to the containers or packs to be labeled.

Alternatively or additionally, the pallet may have applied thereto compressed air for transferring the label. To this end, it will either be possible to connect the already existing suction openings to a compressed air supply, or holes which are specially provided in the contacting surface of the pallet for this purpose may have applied thereto compressed air. By way of example, a leading edge of the conveyed label may be lifted off from the contacting surface by applying compressed air, and may then be placed onto the container to be labeled. By rotating the container to be labeled, the label is subsequently fully applied to the container surface by rolling on. The relative movement between the containers and the pallet will here support this roll-on process. It follows that, for transferring the labels to the containers or packs to be labeled, the use of an additional device, in particular of the normally employed gripper cylinder, will not be necessary according to the present invention. This has the effect that the labeling process can be simplified on the one hand and executed at a more reasonable price on the other. Pressure application can again be controlled by means of an open-loop and/or closed-loop control unit of the labeler.

As has already been mentioned, the label that has been glue-coated by means of the glue printer can then be transferred from the pallet directly, i.e. without any detour via a gripper cylinder, to a container conveyed by a conveyor or a pack conveyed by the conveyor. For this purpose, the glue-coated side of the label can be moved, by pivoting or rotating the pallet, such that a leading edge of the label will be placed onto the surface of the container or pack to be labeled. Subsequently, the label is stripped off from the pallet by a controlled relative movement of the pallet and of the container, and applied to the container by rolling on.

As is in principle known in the prior art, the conveyor may be configured as a container table, a circulating carriage/rail system or the like with a plurality of holders for the containers or packs, said holders being rotatable about their own axis and configured e.g. in the form of rotary plates. By controlled rotation of the rotary plates during transfer of the labels to the containers or packs, the labels are rolled onto the surface of the containers or packs. The track of the containers in the area of label transfer may e.g. be circularly curved, as in the case of a carousellike container table, or straight, as in the case of a long stator linear motor drive or belt drive for the holders. The holders may be provided with individually controllable drive units, e.g. in the form of servomotors. By means of these drive units, the holders can be rotated in a controlled manner, so as to execute predetermined rotary movement profiles for taking over and wrapping the labels onto the containers. It goes without saying that the conveyor may comprise additional elements, which are known per se in the prior art, such as a container feeding device, e.g. in the form of an infeed star wheel, a container discharge device, e.g. in the form of a discharge star wheel, a separating screw or the like.

Due to the fact that the labels are taken over such that their back faces away from the pallet, the glue can be applied by the glue printer directly to the glue application side of the labels, without the detour of applying glue to the pallet or a respective glue segment of a glue carrier. Thus, the glue-coated labels are now conveyed by the pallets with the glue coat facing outwards, so that they can be applied directly from the pallet carousel to the containers to be labeled. Hence, the normally employed gripper cylinder, which was required for turning the labels prior to transferring them to the containers, is no longer necessary. The whole labeling unit can thus be provided with a simpler and more compact structural design. In addition, it will no longer be necessary to carry out maintenance and cleaning work for the gripper cylinder, so that the running life of the unit can be extended.

As has already been mentioned, the method may additionally comprise the step of taking over the label from a label providing unit, in particular by suctionally attracting the image side of the label to a contacting surface of the pallet. The label providing unit may consist of one or a plurality of the label boxes or magazines known in the prior art, which each accommodate a plurality of precut labels and make these labels available at the front side thereof for removal by a pallet. However, according to the present invention, the labels in the label boxes are, other than in the case of the prior art, arranged such that the labels are made available at the front side of the label box with their image side, on which the information to be represented is shown. Taking over of the label by a pallet, which, for this purpose, is moved with its label contacting surface past the front side of the label box, is carried out such that the image side of the transferred label will face the contacting surface, i.e. the pallet, whereas the glue application surface of the label provided on the back of the label will face away from the pallet. Thus, the glue application surface is exposed while the label is being conveyed by the pallet, so that it can have glue applied thereto by the glue printer.

Alternatively to the use of a label box, the labels may also be provided by separating individual labels from a continuous label tape. To this end, the label providing unit may, as is known per se, comprise a stockpiling unit for one or a plurality of label tape rolls, a feed unit for feeding the label tape as well as a cutting unit for separating individual labels from the label tape. The separation may be carried out e.g. by means of a rotating perforating or cutting roll in engagement with the circumferential surface of a mating cutting cylinder, the label tape being here guided between the roll and the mating cutting cylinder. After having been perforated, the labels can be torn off the tape by increasing the conveying speed. The separate labels may subsequently be transferred to the pallet by a vacuum roll. Also in this case, the label tape or the separated labels are oriented such that the glue application surface of the label taken over from the pallet faces away from the contacting surface of the pallet.

Finally, the method may additionally comprise the step of feeding cold glue to the glue printer by controlled deformation of a deformable glue reservoir. In order to allow this, the glue reservoir consists, at least partially, of a material, e.g. a plastic material, sheet metal or a foil, which is deformable by a deformation unit specially configured for this purpose and which is deformed in that it is mechanically acted upon by a deformation element of the deformation unit. The reservoir may e.g. have the shape of a can with an opening for the glue, and a die-shaped deformation element pushes the bottom, which is located opposite to the opening, successively into the interior of the can. The resultant reduction of volume causes an increase in the pressure of the glue in the reservoir, whereby the glue is squeezed out of the reservoir through the opening. By a controlled advance of the deformation element, it will be possible to control the amount of squeezed-out glue on the one hand and the pressure in the reservoir on the other, so that the reservoir walls can be prevented from bursting. Other possible forms of reservoirs are tubes, syringes, spheres and the like, the deformation elements used may then be complementary die- or roll-shaped deformation elements. A suitable structural design of the reservoir and of the deformation element allows a complete removal of the glue contained in the reservoir.

The opening of the reservoir, which is especially configured as an exchangeable reservoir, may be connected, e.g. via a screw coupling, to a complementary connection of the labeler, from where the glue can then be supplied via glue lines to the glue printer, in particular to the glue nozzles or glue channels of the latter. If the ink-jet method is used, the pressure built up through deformation may, at least partially, be used for operating the glue nozzles, so that the use of an additional glue pump can be dispensed with. If higher glue pressures are required, an additional glue pump or booster pump with a possible media pressure of 30 to 90 bar may be provided. It is also imaginable to additionally use a speed mixer or a twin-screw extruder, by means of which the glue is again deaerated and mixed.

As mentioned above, the glue reservoir may be configured as an exchangeable component, provided e.g. with a screw coupling. Thus, the reservoir can easily be replaced after having been emptied, and can then undergo recycling. Moreover, the emptied reservoir has normally been compacted through the deformation, whereby storage and transport costs can be kept low. Due to the fact that precisely the respective amount of glue needed is squeezed out of the reservoir, a glue return flow can be dispensed with completely. In order to obtain an optimum processing temperature for the glue used, the reservoir and the glue lines or, alternatively, a cabinet-like housing of the reservoir and of the deformation unit may be cooled or heated, if necessary. For this purpose, suitable cooling or heating devices may be provided, which may in particular be configured as controllable elements.

The above-mentioned objects are also achieved by an apparatus for carrying out the above-mentioned methods. The apparatus may here especially have the apparatus features described hereinafter.

Likewise, the above-mentioned objects are achieved by an apparatus for preparing labels for application to containers, comprising a conveying unit for labels and a controllable glue printer, wherein the conveying unit and the glue printer are configured such that, by means of the glue printer, cold glue can be applied in a variable glue image directly onto a glue application surface of at least one label conveyed by the conveying unit.

The same variations and further developments, which have been described hereinbefore in connection with the method for preparing labels for application to containers according to the present invention, are also applicable to the apparatus for preparing labels for application to containers. In particular, the conveying unit may be configured such that labels of different sizes and formats can be conveyed thereby along a predetermined track in such a way that the glue application surface on the back of the conveyed labels will be exposed for direct glue application by means of the glue printer arranged at the track. As has been described hereinbefore, an open-loop and/or closed-loop control unit may additionally be provided, which controls the conveyance of the labels through the conveying unit by open-loop and/or closed-loop control such that a two-dimensional glue image of an almost arbitrary nature can be applied to the glue application surface.

According to a further development, the glue printer may comprise a plurality of glue nozzles controllable individually or in groups, in particular according to the principle of an ink-jet head. To this end, the glue printer has a print head comprising a plurality of controllable glue nozzles or glue channels, which are arranged relative to a path of movement of the label conveyed by the conveying unit, such that the glue to be applied will be sprayed onto the glue application surface of the label while the latter is passing by. Depending on the size of the distance chosen between the opening of the glue nozzles and the glue application surface, application may take place in the form of a jet with glue drops separating from the nozzle opening or in a quasi-contact mode, where the distance is smaller than the typical diameter of the glue drops. In the first case, the distance may e.g. be between 1 mm and 2.5 mm, whereas in the second case it will be less than 1 mm. The glue nozzles or glue channels may be arranged along one or a plurality of parallel rows, which are oriented perpendicular to the path of movement of the label and tangentially to the contacting surface. Neighboring rows may be “staggered” relative to one another in a vertical direction so as to increase the print resolution of the glue image. In addition, the print head may be configured for pivoting about a vertical and/or horizontal axis so that an optimum impingement angle for the glue drops can be adjusted.

As has already been described, the glue nozzles or glue channels may accurately be activated and deactivated, individually or in groups, so as to be able to print a glue image, which is adapted to the label format, onto the glue application surface of the label while the latter is passing by. Also in this case, control may take place after the fashion of a type management by means of an open-loop and/or closed-loop control unit and respective glue images stored in a memory unit. The glue print head may operate according to the DoD technology (drop-on-demand) or with a continuous jet. In the latter case, a glue return flow for excess glue to the glue supply line, through which the print head is supplied with glue, or to the glue reservoir may be provided, as has already been mentioned. Making use of the print heads described, almost arbitrary glue images can be produced. In addition, the glue may be applied in a contact-free manner, so that the label will neither shift on nor be stripped off from a pallet of the conveying unit. As described above, the glue application surface to be glue-coated can, in the area of the glue printer, be caused to pass by with a desired speed and at a desired distance from the discharge openings of the glue nozzles or glue channels by controlled pivoting of the pallets of a further development of the conveying unit.

The conveying unit for the labels may have a great variety of different structural designs. For example, it may be configured as a vacuum roll or a gripper cylinder arranged as a label transfer device between the above-mentioned label providing unit and the conveyor for the containers. In this case, the above-described glue printer used for applying glue to the labels may be arranged on the circumferential side of the vacuum roll or of the gripper cylinder. Alternatively, the conveying unit may comprise a plurality of circulatorily driven pallets for the labels, the drive of the pallets being realizable through a long stator linear motor drive in the form of a carriage/rail system or by means of a belt drive.

According to a special further development, the conveying unit may comprise a pallet carousel with a plurality of pallets, which are adapted to be driven such that they circulate around an axis of rotation and which, in particular, are pivotable about pivot axles displaced relative to the axis of rotation in a radial direction. As has already been mentioned, such a pallet carousel is, in principle, known from U.S. Pat. No. 3,736,213. As described above, the pallets may eccentrically be supported on their pivot axles such that the curved contacting surface of the pallet will roll optimally, i.e. without slipping, on a flat surface of the type defined e.g. by the image side of a label provided by a label box. Such flat rolling-on can also take place when the labels are being transferred to linearly conveyed containers or to a cyclically operated container table, in the case of which the container holder is only rotated, but not advanced, during transfer. In the latter case, an eccentric support can be completely dispensed with. By increasing the eccentricity of the support of the pallets, it will additionally be possible to realize optimal rolling-on also on a curved surface, as will be the case e.g. when the containers are conveyed by means of a container table in a continuous mode. The roll-on movement is here obtained by a superposition of the container rotation and the movement of the holders in combination with the circulation of the pallets around the axis of rotation of the pallet carousel and the pivotal movement of the pallets about the respective pivot axle. In the simplest case, the curved contacting surfaces of the pallets are configured as circular segments of a cylinder. Alternatively, the curvature of the contacting surface may, however, also vary along the contacting surface such that an optimum roll-on behavior is obtained also in the case of a centric support. However, an eccentric support will normally take up less space than a centric one, so that more pallets can be accommodated on a pallet carrier rotating about an axis of rotation.

As has already been mentioned, the supports of the pallets on the pallet carrier may be configured such that the eccentricity of the pivot axle can be changed during circulation around the axis of rotation. To this end, the support may be changed with respect to the contacting surface e.g. by means of a controllable linear actuator. The control of the linear actuator can be adapted by means of the above-mentioned open-loop and/or closed-loop control unit, depending on a position of the pallet along the circulatory path. For example, the eccentricity prevailing when a label is taken over from a label box may be smaller than that at the point where the label is transferred to the containers guided on a container table. The change in the eccentricity of support may alternatively also be changed automatically by means of one or a plurality of control cams of the pallet carousel, possibly in cooperation with a resetting-type spring device for the support, while the pallets circulate around the axis of rotation of the carousel. The control cams may here simultaneously also cause pivoting of the pallets. Alternatively, the pivotal movement and/or rotation of the pallets may be effected by means of one or a plurality of servomotors. Also in this case, control will again be executed by a suitable open-loop and/or closed-loop control unit of the labeling machine.

According to the present invention, a glue printer is arranged on the circumference of the pallet carousel downstream of the label providing unit described hereinafter, when seen in the direction of circulation. Due to the fact that the pallets circulate around the axis of rotation, the glue application surfaces of said pallets are moved past the glue printer and have cold glue applied thereto, at least over part of their area. As has already been described, a variable glue image can thus be printed, according to the ink-jet method, onto the glue application surface of the label which is moved past the discharge openings of the glue nozzles of the glue printer. The glue is here applied directly to the glue application surface of the conveyed labels, which faces away from the pallet. Since the glue-coated side of the labels thus faces outwards, the conveying unit may simultaneously be used for applying the labels directly onto the containers or packs to be labeled. Hence, the normally employed gripper cylinder is no longer necessary, whereby the whole system can be provided with a more compact and less expensive structural design.

According to a further development, the apparatus may additionally comprise a vacuum supply unit, in particular a vacuum pump, each pallet being here configured as a vacuum pallet with a plurality of suction openings on a contacting surface of the pallet for the labels to be conveyed. The suction openings may here result from the natural porosity of a vacuum pad defining the contacting surface and consisting e.g. of a sintered plastic material. The suction openings may, however, also be defined by holes in the contacting surface of the pallet, which may be arranged in the form of a matrix, as has been described hereinbefore. In addition, the suction openings may be distributed over the contacting surface of the pallet according to the likelihood with which they will be required for conveying a certain label format, so that more suction openings will be provided at locations where a part of the label to be conveyed comes to lie with high likelihood. It goes without saying that the apparatus may comprise additional elements of a vacuum system which are known per se, such as e.g. vacuum lines supplying the suction openings continuously or in a controlled manner with negative pressure from the vacuum pump. Furthermore, the vacuum pump may be controllable.

If the pallets are configured as vacuum pallets, a direct mechanical contact between the pallet and the label provided by the above-mentioned label providing unit can be dispensed with insofar as, for small distances, the suction power of the suction openings will suffice for taking the labels over from the label providing unit. The pallets, in particular the pivotal movement thereof, can thus be controlled more easily, and wear of the labeling machine will be reduced. In addition, the adhesion established by the suction openings allows the labels to be taken over by pallets having no glue coat, so that the labels can be conveyed with their image side facing the pallets. Consequently, the labels can, after having been glue coated by the glue printer, be applied to the containers directly, i.e. without a gripper cylinder.

According to a special further development the pallet may, as has already been mentioned, be configured such that the suction openings can be supplied with negative pressure individually or in groups. In addition, the apparatus may comprise an open-loop and/or closed-loop control unit, which is configured to control the negative pressure supply of the suction openings and/or the activation of the glue nozzles depending on a shape and/or size of the labels. Individual ones or groups of the suction openings may be provided with control valves in their vacuum supply lines, and these control valves may e.g. be miniaturized as piezoelectric elements. The suction openings may also be connected in groups to a respective vacuum line that is adapted to be closed by a control valve. The groups may here preferably be defined depending on frequently used label formats. A single vacuum palette can thus be used in a flexible manner for conveying a plurality of label formats.

The control valves may be provided as part of the open-loop and/or closed-loop control unit, which accurately supplies the suction openings of the pallet with negative pressure. For this purpose, the above-mentioned control valves may be connected via respective signal lines to the open-loop and/or closed-loop control unit, which opens or closes the valves, according to requirements, depending on the processed label format. Which valves are to be opened for a specific label format and which valves are to be closed may be stored, after the fashion of a type management, in a memory unit of the open-loop and/or closed-loop control unit and can be retrieved therefrom by a processor unit of the open-loop and/or closed-loop control unit for changing over to a different label format. A product change can thus be accomplished in a particularly easy manner.

Such change of the label format can be carried out even more easily, if the suction openings are provided with valves in such a way that, when a mechanical contact with the label to be taken over is established, they will automatically be connected to the negative pressure supply. This can be accomplished e.g. by providing the suction openings with individual touch valves, which are opened by pressure applied to a push element. The label surface contacting the touch valve is thus automatically subjected to the negative pressure communicated through the associated suction opening and will therefore adhere to the pallet. According to a further development, the suction openings may be configured, with or without a touch valve, in the form of suction cups, so as to maximize the effect of the negative pressure. Other than in the case of the above-described holes, the suction cups project here beyond a base of the pallet, and the control may take place via control valves or touch valves as described above.

As has already been mentioned, the vacuum pallets may also be configured such that retrofitting to a different label format can be accomplished by inserting or pushing in an accessory, e.g. in the form of a hole template. The accessory will here prevent access of the non-required suction openings to the negative pressure supply. As has already been mentioned hereinbefore, a control of the suction openings may also be dispensed with completely, when higher vacuum losses are accepted.

In all the above-mentioned cases, the vacuum pallets may be configured sufficiently large for allowing the handling of a plurality of label formats to be processed. Additionally or alternatively to the individual or groupwise control of the suction openings, the negative pressure supply of the vacuum pallet in its entirety may be controlled depending on a position of the vacuum palette along its circulatory path around the axis of rotation. For example, the negative pressure supply for the whole pallet may be activated in the area of the label providing unit, so as to take over a label, and deactivated in the area of the conveyor, so as to transfer the label to the container to be labeled. To this end, the negative pressure supply unit may comprise one or a plurality of suitable control valves in the supply lines of the pallets, said control valves being controlled by the open-loop and/or closed-loop control unit. Also a rotary distributor for vacuum transfer to the pallets is imaginable.

According to a special further development, the labeler may comprise an interrupter, which is configured for interrupting the negative pressure supply of the pallet, when the label is applied to the containers or packs. This interrupter may be configured as a mechanical element blocking the negative pressure supply in the area of transfer of the label, or as part of the open-loop and/or closed-loop control unit ensuring that the control valves of the pallet or of the supply line will be closed for transferring the label. Transferring the label to the container to be labeled can be facilitated by interrupting the negative pressure supply.

In addition, the labeler may comprise a compressed air system which communicates with the pallets via compressed air lines such that at least part of the suction openings or holes provided separately for this purpose in the contacting surface can be acted upon by compressed air in a controlled manner. Also in this case, the control may take place via suitable control valves and by means of the open-loop and/or closed-loop control unit. Due to the compressed air flowing out, the label can be released from the contacting surface and the suction cups, respectively, in a particularly easy manner and placed on and pressed onto the container.

The glue-coated labels can be applied to the containers by controlled pivoting of the pallets. In order to allow also a reliable application of shoulder labels, the pallets may additionally be configured such that they are a pivotable about a horizontal axis, the tilt angle being controllable especially by means of a control cam of the conveying unit.

According to another further development, the apparatus may, as described above, additionally comprise a controllable deformation unit for removing cold glue from a deformable reservoir by deforming the reservoir. The deformation unit may here be configured in the way that has already been described hereinbefore, in particular with respect to the deformation element, the connection to the supply line of the glue printer and the control of deformation. Likewise, the reservoirs used for the cold glue may be configured as described above.

Furthermore, the apparatus may comprise a conveyor for the containers to be labeled. The conveyor may, as has been mentioned hereinbefore, be configured as a container table, a circulating carriage/rail system or the like with a plurality of holders for the containers or packs, said holders being rotatable about their own axis and configured e.g. in the form of rotary plates. The holders may circulate on a container table in the form of a carousel on a circular track or they may be moved linearly in the area of label transfer to the containers or packs, e.g. by means of a belt drive or a chain drive, a conveyor belt or a long stator linear motor drive. The holders may be provided with individually controllable drive units, e.g. in the form of servomotors, by means of which they can be rotated in a controlled manner, so as to execute predetermined rotary movement profiles for taking over and wrapping the labels onto the containers. To this end, the holders may hold the containers from below, as in the case of rotary plates, and/or fix them from above, as e.g. in the case of centering bells. It goes without saying that the conveyor may comprise additional elements, which are known per se in the prior art, such as a container feeding device, e.g. in the form of an infeed star wheel, a container discharge device, e.g. in the form of a discharge star wheel, a separating screw or the like.

Finally, the apparatus may comprise a label providing unit, and said label providing unit may comprise one or a plurality of label boxes for providing individual labels. Alternatively, the label providing unit may be configured such that it comprises a stockpiling unit for one or a plurality of label tape rolls, a feed unit for feeding the label tape as well as a cutting unit for separating individual labels from the label tape. As has already been mentioned and as is known per se, a rotating perforating or cutting roll in engagement with the circumferential surface of a mating cutting cylinder may be provided for this purpose, and the mating cutting cylinder may here be configured as a vacuum roll on which the separated labels are held by means of negative pressure. The labels can be taken over from the vacuum roll or the label box by the at least one pallet. The labels in the label box or the label tape on the mating cutting cylinder are here oriented such that they will be taken over by the pallet with their image side, i.e. with their image side facing the contacting surface of the pallet and, consequently, with their glue application side facing away from the pallet. It follows that the conveying unit is arranged relative to the label providing unit such that, for taking over the labels, the pallets are guided such that their contacting surface will move tangentially past the label box or the vacuum roll. For transferring the labels, a mechanical contact between the pallet and the label can be established, or transfer may be effected through negative pressure in that the pallet passes by at a small distance. The vacuum roll and the conveying unit may have provided between them additional elements, such as a further vacuum roll or a gripper cylinder, which, for separating the labels of a perforated label tape, rotate at a higher speed than the mating cutting cylinder. The orientation of the label tape will be suitably adapted in this case.

The methods and apparatuses described allow a direct application of glue to the back of labels and the subsequent direct transfer of the labels to the containers to be labeled. The normally used gripper cylinder can thus be dispensed with. By using a glue printer as a glue application unit, it is, moreover, no longer necessary to use the maintenance-prone glue roller. In addition, making use of such a glue printer, an arbitrary glue image can be applied to any label format that can be conveyed by means of the pallet. By suitably configuring the vacuum pallet, a great variety of different label formats can thus be processed without retrofitting the labeler. In particular, a change of pallets will no longer be necessary for this purpose. Since the gripper cylinder is no longer required, glue can, moreover, normally be applied up to the edge of the label, whereby reliable adherence of the label to the container surface can be guaranteed.

According to the present invention, the glue is preferably applied directly to the glue application surface of the labels. The special further developments of the controllable glue printer may, however, also be subsequently provided in the case of already existing labelers applying the glue by means of a glue roller to the contacting surface of the pallets, so as to remove then a label from the label magazine with the glue application side. In this case, the glue roller will simply be replaced by the above-described glue printer, and the controllable deformation unit, which has also been described hereinbefore, may be used in this connection for supplying the glue printer with cold glue. The application of glue to the contacting surface must here take place precisely, since after the transfer of the labels by the gripper cylinder that is here arranged between the pallet carousel and the conveyor a small amount of glue will still adhere to the pallet. It follows that existing labeling units can easily be retrofitted by replacing the glue roller by a glue printer, and the hitherto necessary glue return flow can be completely dispensed with.

Additional features and exemplary embodiments as well as advantages of the present invention will be explained in more detail hereinafter with reference to the drawings. It goes without saying that the embodiments do not exhaust the scope of the present invention. It also goes without saying that some or all of the features described hereinafter may also be combined with one another in other ways.

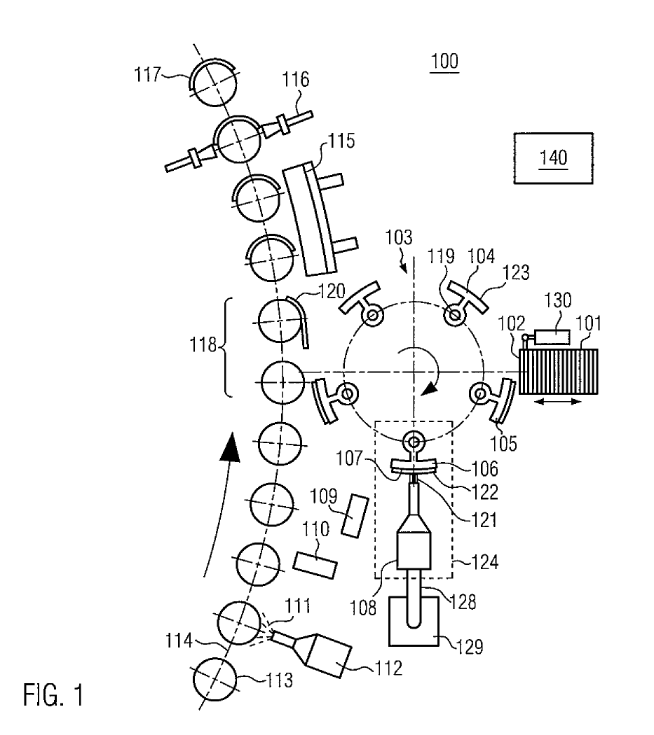

FIG. 1 shows schematically a top view of a labeler according to the present invention.

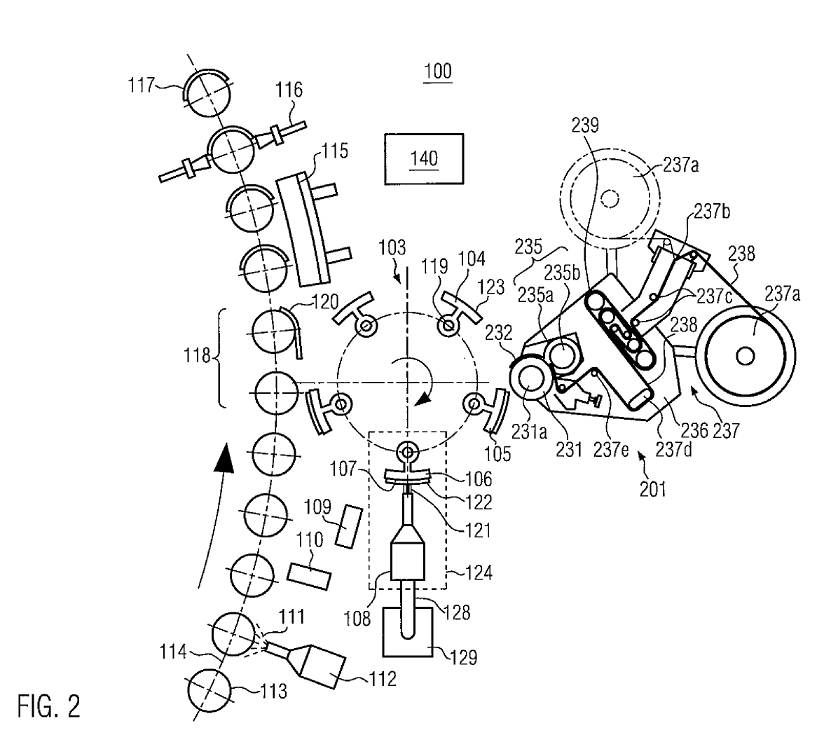

FIG. 2 shows a variation of the labeler of FIG. 1 for label tapes.

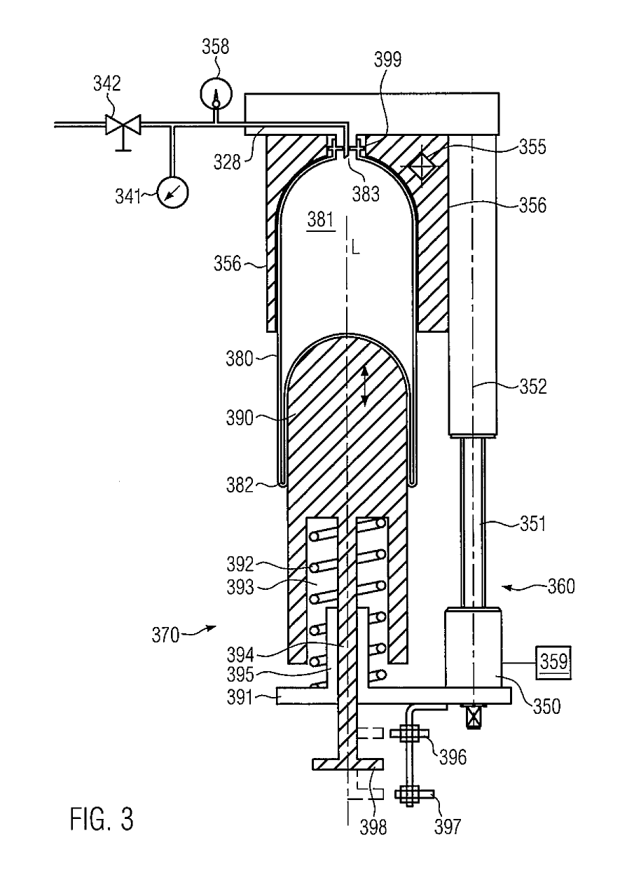

FIG. 3 shows a cross-section through a schematic representation of a device for removing cold glue by deformation of a reservoir according to the present invention.

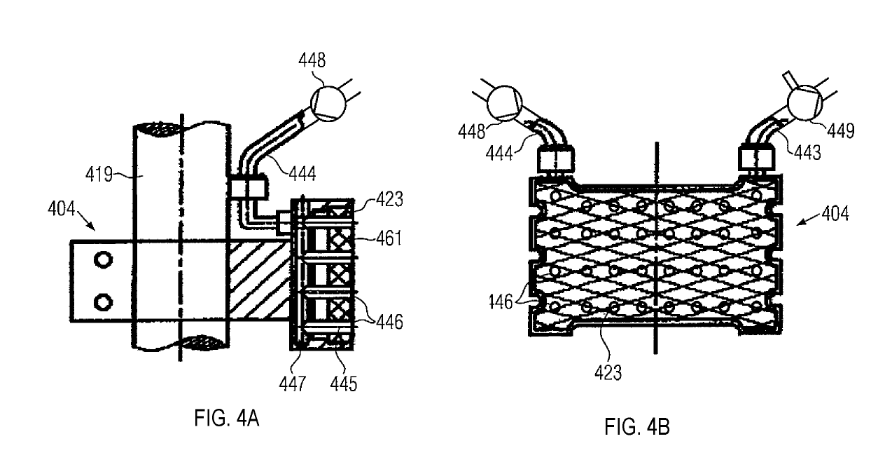

FIG. 4a shows a side view of an exemplary vacuum pallet according to the present invention.

FIG. 4b shows a front view of the vacuum pallet according to FIG. 4a.

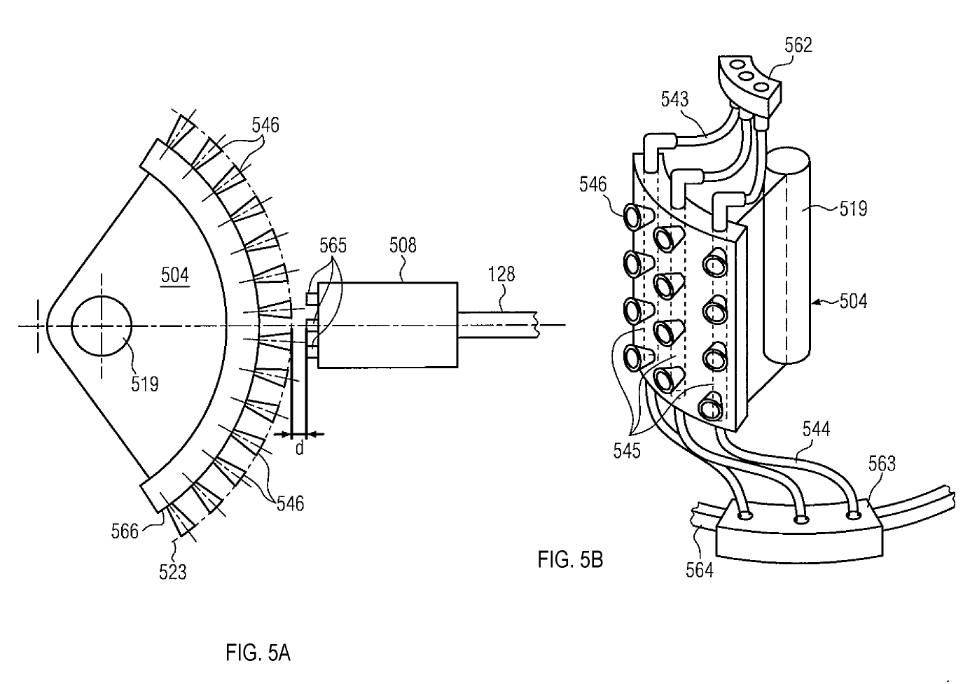

FIG. 5a shows a schematic cross-section of an alternative embodiment of a vacuum pallet according to the present invention.

FIG. 5b shows a perspective view of the vacuum pallet according to FIG. 5a.

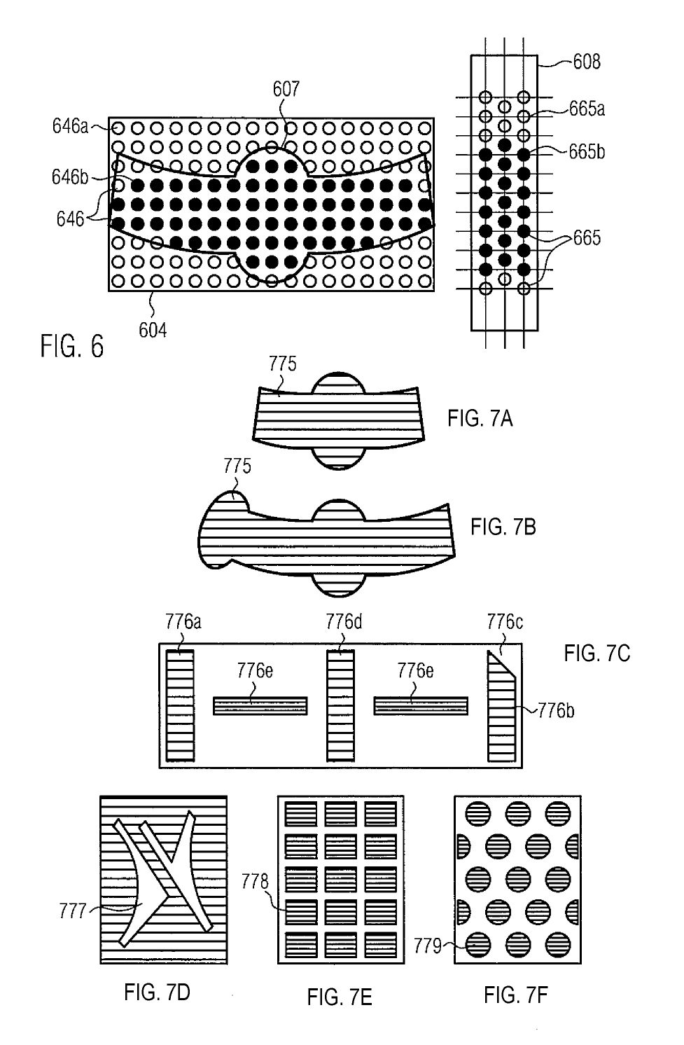

FIG. 6 shows schematic front views of a vacuum pallet and of a glue nozzle array of a glue printer according to the present invention.

FIG. 7a-f show exemplary label formats and glue images.

In the following, identical or similar elements are designated by identical reference numerals. These elements will not be described repeatedly for the sake of clarity. In addition, it goes without saying that in the following embodiments some of the elements or all of the elements can be replaced by or combined with similar elements described in connection with other embodiments.

FIG. 1 shows a schematic representation of a labeler according to the present invention in a top view. In the further development shown here the labeler 100 comprises a conveyor, which is configured as a container table 114 and along which the containers 113 or packs to be labeled circulate on a curved track on a plurality of holders that are rotatable about their own axis (not shown). The depicted, non-limiting further development additionally shows further frequently used elements of a labeler. For example, a pretreating unit 112 may be provided, which prepares the container to be labeled 113 for the labeling process by cleaning and premoistening the container surface to be labeled or by subjecting said container surface to blow cleaning, a heating and/or radiation and/or plasma and/or corona treatment. In addition, sensors 109 and 110 may be provided, which measure the condition of the surface to be labeled, e.g. smooth, rough, etc., and/or ambient conditions, such as e.g. an ambient temperature or humidity, and transmit this information to the open-loop and/or closed-loop control unit 140 for controlling the labeler. Furthermore, a roll-on unit 115 and/or a brush-on unit 116 may be provided downstream of the labeling position 118, so as to fully apply the label 120 placed onto the container and press it onto the latter. The containers provided with the label 117 are then transferred to a subsequent treatment station, e.g. a filling station for filling with a liquid foodstuff.

According to the present invention, the labeler 100 comprises a conveying unit 103 with at least one pallet 104-106. In the further development shown, the conveying unit 103 is configured as a pallet carousel comprising a plurality of pallets 104-106, which circulate around an axis of rotation of the pallet carousel and which, in turn, are configured such that they are pivotable about eccentrically supported pivot axles 119 of their own. The pallets have on their outwardly directed side a contacting surface 123, which may be sufficiently large for accommodating a plurality of different label formats. While circulating around the axis of rotation of the pallet carousel 103, the initially unladen pallet 104 is moved past a label magazine 101 in the form of a label box, which is arranged on the periphery of the pallet carousel, and simultaneously pivoted such that the contacting surface 123 of the pallet will take over from the label box 101 the frontmost label 102 presented with its image side. Since, as will be described hereinafter in more detail, the pallets 104-106 are configured as vacuum pallets, this transfer can reliably be carried out even without applying glue to the contacting surface 123 in advance. In order to be able to adapt the distance between the frontmost label 102 and the pallet carousel 103, the label box 101 may be configured such that it can be switched via a pneumatic cylinder 130.

Since the labels 102 are provided such that their image side faces forwards, they will also come to lie with their image side on the contacting surface 123 of the pallet 105. It follows that the glue application surface 122 of the labels 107 conveyed by the pallets 105 and 106 faces away from the contacting surface of the respective pallet. The thus outwardly directed glue application surface of the label 107 can therefore have glue applied thereto directly on the pallet by means of a glue application unit 124 arranged on the circulation path of the pallets 104-106, i.e. on the circumference of the pallet carousel 103. FIG. 1 shows, according to the present invention, a glue application unit 124 operating according to the ink-jet method.

When a glue printer 108 is used, the cold glue is sprayed directly onto the glue application surface 122 in the form of a glue jet 121 from a plurality of glue nozzles. To this end, the glue application surface 122 is moved past the openings of the glue nozzles preferably at a constant distance therefrom by circulating and pivoting the pallet 106. By accurately controlling the glue nozzles, e.g. according to the DoD principle (drop-on-demand), an almost arbitrary glue image can be printed onto the glue application surface 122 in superposition with the pallet movement. In particular, precisely the necessary amount of cold glue can be applied by printing, so that a glue return flow can be dispensed with completely.

The supply of glue to the glue printer 108 via the glue supply line 128 can be effected in a controlled manner and in the quantity required by means of one of the above-described controllable deformation units. This is indicated in FIG. 1 for the glue application unit 124. An exemplary further development of the deformation unit 129 will be described hereinafter in connection with FIG. 3.

Since the cold glue is applied to the outwardly directed glue application surface 122, a gripper cylinder for placing the now glue-coated labels 107 onto the containers to be labeled 113 is, other than is normally the case in the prior art, not necessary. Instead, the labels are placed directly from the pallets 104-106 onto the containers 113 moving past the labeling position 118, and are wrapped therearound by a rotary movement of the holders of the container table 114. To this end, the pallets are moved past the container surfaces and simultaneously pivoted such that, in combination with the rotary movement of the containers and their circulatory movement around the container table, the carried-along labels will be applied to the container surfaces by rolling on. As has already been mentioned, a slip-free roll-on application of the labels to the container surfaces can be accomplished by a suitable eccentric support of the curved pallets 104-106 on their respective pivot axles 119, so that the labels applied will not shift unintentionally.

The circulatory movements of the pallets 104-106 and of the holders of the container table 114 may be controlled by means of controllable drives (not shown) via the open-loop and/or closed-loop control unit 140 of the labeler 100. Likewise, the rotary movement of the holders for the containers can be controlled in an open loop and/or in a closed loop mode by means of the open-loop and/or closed-loop control unit. The pivotal movements of the pallets 104-106 can be controlled in an open loop and/or in a closed loop mode by means of the open-loop and/or closed-loop control unit via suitable control cams or also via servomotors that are specially provided for this purpose. Finally, the vacuum supply and the glue nozzles can be controlled via the open-loop and/or closed-loop control unit 140 as described hereinafter. The open-loop and/or closed-loop control unit may especially be a programmable logic control unit comprising a memory unit, e.g. in the form of a flash memory, having stored therein the storage parameters, e.g. with respect to the desired glue image, required for the purpose of control.

FIG. 2 shows a variation of the further development according to FIG. 1 comprising a label-tape providing unit 201. As has already been mentioned, like reference numerals designate like elements, so that a renewed description is dispensed with for the sake of clarity. According to this further development, the labels are, however, provided in the form of label tapes, instead of a label magazine, the individual labels being separated from these label tapes by means of a cutting unit.

A base frame 236 has arranged thereon a feed unit 237 for feeding a label tape 238 with a plurality of labels that are not glue-coated. In the further development shown, the feed unit 237 comprises two stocking units 237a, e.g. in the form of label tape rolls, a splicing unit 237b for automatic roll exchange, deflection rollers 237c, a loop buffer 239, a track control unit 237d for guiding the label tape 238, and a conveying unit 237e including e.g. a spring-loaded drive roller for the label tape.

In addition, a cutting unit 235 and a transfer cylinder 231 are provided downstream of the feed unit 237. The cutting unit 235 is shown with a rotor 235a driven by an individually controllable drive unit 235b with the desired rotational frequency. The blades (not shown) secured to the rotor 235a cut the fed label tape 238 into individual labels 232, which are then transferred to the pallets 104-106. Cutting of the label tape 238 is carried out in engagement with the mating cutting cylinder 231, which also serves as a transfer cylinder for transferring the labels 232 to the pallets 104-106. The transfer cylinder 231 is here preferably configured as a vacuum cylinder having suction openings formed in its circumferential surface, e.g. as a so-called vacuum roll, the label tape or the labels being suctionally attracted to said vacuum roll and held thereon. The transfer cylinder 231 may be driven via an individually controllable drive unit 231a synchronously with the rotary movement of the rotor 235a. Analogously to the above-described taking over from a label box, the separated labels 232 are, also according to this further development, taken over by moving the pallets 104-106 past the transfer cylinder 231. The circulatory and pivotal movements of the pallets 104-106 are here controlled by the open-loop and/or closed-loop control unit 140 in accordance with the rotational frequency of the mating cutting cylinder 232.

FIG. 3 shows a cross-section through a schematic representation of a cold-glue removing device 370 according to the present invention. When such a device is used, the removal of glue from a deformable reservoir 380 is carried out in that a deformation unit 360 acts on the reservoir, whereby the glue accommodation volume 381 of the latter is reduced. The resultant pressure in the glue squeezes the amount of glue to be removed out of an opening 383 of the reservoir.

In the non-limiting embodiment shown here, the deformation of the reservoir 380 is effected in that the wall of the reservoir is directly mechanically acted upon by a deformation element 390. To this end, the deformation element 390 according to this embodiment is adapted to be moved relative to the reservoir 380 along the longitudinal direction L by means of a motor 350, which causes a spindle 351 to move, said spindle engaging a stationary complementary mating thread 352. The motor 350 may be configured for being controlled in an open-loop and/or closed-loop mode, so that this relative movement can be controlled in an open-loop and/or closed-loop mode by means of an open-loop and/or closed-loop control unit 359. In the embodiment shown in the present figure, the part of the removing device 370 holding the reservoir 380 is stationary, whereas the deformation element 390 moves relative thereto. It goes without saying that the arrangement can be modified such that, alternatively or additionally, the reservoir can be moved relative to the deformation element.

The reservoir 380 has its opening 383 connected to a connection 399 of the apparatus, e.g. via a screw thread. Owing to the screw thread, an empty reservoir can thus easily be replaced by a full reservoir. Via the opening 383 and the connection 399, the squeezed-out glue is transferred to a conveying line 328, which, as has been mentioned hereinbefore, advances the glue to the glue printer. The conveying line may be provided with a control valve 342 so that the dispensed amount of glue can be controlled precisely. Furthermore, a pressure sensor 341 and/or a temperature sensor 358 may be provided, said sensors measuring the pressure and the temperature of the glue in the conveying line 328. The measured data can be transmitted to the open-loop and/or closed-loop control unit 359 and can thus be incorporated into the open-loop and/or closed-loop control of the motor 350 of the drive unit.

In the embodiment shown here, the deformation element 390 is supported on a carrier 391, the deformation element and the carrier having provided between them a spring 392 which biases the deformation element against the carrier. The spring 392 shown is here arranged in an opening 393 of the deformation element 390. Furthermore, the deformation element 390 comprises a rod 394 guided in a guide 395 of the carrier 391. According to the present embodiment, the carrier 391 has arranged thereon two sensors 396 and 397, which detect a position of a projection 398 arranged on the rod 394. Depending on signals emitted by these sensors, which may e.g. be light barriers or magnetically operating sensors, a movement of the carrier 391 can be controlled such that the projection 398 will always be located between the two sensors 396 and 397. In this way, a predetermined force applied by the spring 392 to the deformation element 390 can be adjusted and, consequently, also a predetermined pressure on the glue contained in the reservoir 380. An excessive pressure, which may result in tearing of the reservoir wall, can thus be avoided effectively.

By a relative displacement of the deformation element 390 along the longitudinal direction L, the surface of the deformation element, which is configured such that it resembles the shape of the upper part of the reservoir 380, can first be brought into mechanical contact with the lower part of the reservoir and then be moved into the reservoir by further displacement. In the course of this process, the reservoir will be deformed such that the lower part of its wall is pushed into the accommodation volume 381, so that a curved edge 382 of the deformed reservoir 380 will be obtained. As the displacement of the deformation element 390 continues, the wall of the reservoir will be pushed into the interior of the reservoir further and further. This has the effect that almost all the glue contained in the reservoir will gradually be squeezed out of the latter. The shape of the reservoir 380 and of the deformation element 390 can be chosen such that the number of gaps for glue which are formed during the deformation process will be as small as possible. Accordingly, a die-shaped deformation element may, as shown here, be configured with a slightly smaller cross-sectional area than that of the reservoir, so that it can be pushed into said reservoir.

The wall or at least the deformable part of the wall of the reservoir 380 is formed of a material, e.g. PET, which is adapted to be deformed by means of the force exertable by the deformation unit 360, and has a suitable wall thickness. Different areas of the wall may consist of different materials and/or be formed with different wall thicknesses. In particular, it is desirable that, in the further development shown, the upper part of the reservoir 380, which is not to be deformed, will not deform and thus bulge, since otherwise complete emptying of the reservoir and a controlled glue pressure cannot be guaranteed. In order to stabilize the part of the wall of the reservoir 380 which is not to be deformed, the deformation unit shown here comprises a housing 356 for accommodating this part of the reservoir, said housing being brought into contact with an outer surface of the reservoir part which is not to be deformed, in such a way that it encloses this part in a sleevelike manner. The part of the reservoir wall which is in direct mechanical contact with the housing 356 is thus prevented from bulging due to the increasing pressure in the accommodation volume 381. Moreover, the housing 356 may be provided with a controllable heating and/or cooling device 355 allowing the glue contained in the accommodation volume 381 to be heated or cooled to an optimum processing temperature. The heating and/or cooling device 355 may here be controlled with due regard to the glue temperature measured by the temperature sensor 358.

A large number of alternative embodiments of the removing device 370 is imaginable. For example, the deformation element 390 may be configured as a stationary element, whereas the reservoir 380 is moved by the drive unit 350. In addition, the connection 399 for the opening 383 may be arranged below the reservoir 380. It is also imaginable to configure the connection 399 and part of the conveying line 328 as part of the deformation element 390, the conveying line 328 comprising, in the case of a moving deformation element 390, preferably at least one flexible part. The shape and the nature of the deformation unit 360 may additionally be adapted to the possible shapes of the reservoir.

FIG. 4a shows a side view of an exemplary vacuum pallet 404 according to the present invention. FIG. 4b shows the associated front view of the pallet. According to this non-limiting further development, the pallet shown is supported eccentrically such that it is pivotable about a pivot axle 419. In addition, the vacuum pallet 404 shown is provided with a vacuum pad 461 consisting of a porous sintered plastic material, such as polytetrafluoroethylene (PTFE) or hard polyethylene (high-density polyethylene—HDPE), whose microchannels transmit the negative pressure generated by a vacuum pump 449 via a vacuum supply line 443 to the label contacting surface 423 of the vacuum pallet 404. Alternatively or additionally, a plurality of suction openings 446 may be provided in the contacting surface 423 as shown in the figures, said suction openings communicating via channels 445 with one or a plurality of main channels 447. The main channel 447 may, in turn, communicate with the vacuum supply line 443 and may thus be supplied with negative pressure. Alternatively or additionally, the main channel 447 may communicate via a compressed air supply line 444 with a compressed air supply unit 448, e.g. a pump, so that the openings 446 can have applied thereto compressed air for detaching a conveyed label. The vacuum supply lines 443 and the compressed air supply lines 444 of a plurality of pallets may here be connected via a common, or via two separate rotary distributors to the vacuum pump 449 and the compressed air supply unit 448, respectively.

The vacuum pump 449 and the compressor 448 may be controllably configured in such a way that, depending on the position of the vacuum pallet 404 circulating around the pallet carousel 103, said pallet can have applied thereto negative pressure or compressed air by means of the open-loop and/or closed-loop control unit 140 of the labeler as described above. Alternatively or additionally, control valves (not shown) may be provided in the supply lines 443 and 444, said control valves being opened and closed by the open-loop and/or closed-loop control unit 140 in a controlled manner. Likewise, in particular piezoelectrically configured control valves, which can be opened and closed individually or in groups by means of the open-loop and/or closed-loop control unit 140, may be provided in individual channels 445 for the suction openings 446. In this way, a supply of the suction openings with negative pressure adapted to the format of the labels to be conveyed can be realized, as shown e.g. on the left hand side of FIG. 6.

FIG. 5a shows a schematic cross-section of an alternative embodiment of a vacuum pallet according to the present invention. In addition, this subfigure shows a cross-section of the glue application unit configured as a glue printer 508. FIG. 5b additionally shows a perspective view of the vacuum pallet 504. As has already been described more than once, the figures show a vacuum pallet 504 which is eccentrically supported on a pivot axle 519, the vacuum pallet according to the present further development having, however, a plurality of suction openings in the form of suction cups 546 on its curved outer surface. Hence, the openings of the suction cups 546 define the label contacting surface 523 which extends above the base area 566 of the pallet. By suitably configuring the suction cups such that they comprise touch valves, the suction cups occupied by a label can automatically be activated by the mechanical contact of the label with the push element of the touch valve.

In the non-limiting further development shown, the suction cups 546 of the vacuum pallet 504 are groupwise connected via supply channels 545 to a vacuum distributor 562 as well as to a compressed air distributor 563. For this purpose, the supply channels have one of their ends connected to vacuum supply lines 543, whereas the opposite ends are connected to compressed air supply lines 544. The vacuum distributor 562 and/or the compressed air distributor 563 may especially be configured as rotary distributors, e.g. by providing an annular compressed air supply 564. The pallet 504 can thus be supplied with negative pressure and compressed air, respectively, along its entire circulatory movement around the pallet carousel 103. Just as in the case of the embodiment according to FIG. 4, suitable control valves, which are, however, not shown for the sake of clarity, may also be provided in this case.

Subfigure additionally shows a schematic cross-section of a glue printer 508 operating according to the ink-jet method. Via a glue supply line 128, the cold glue is, in proper doses, supplied to the glue printer 508, e.g. by means of the above-described removing device, said glue printer spraying the cold glue via a plurality of glue nozzles 565 directly onto the glue application surface of a label conveyed by the vacuum pallet 504. By pivoting the vacuum pallet 504 about the pivot axle 519, the glue application surface is moved past the glue nozzles 565 preferably at a constant distance d therefrom, so that by controlled activation and deactivation of the glue nozzles an almost arbitrary glue image can be applied to the label. Control of the glue nozzles can here be executed by the open-loop and/or closed-loop control unit 140.

As shown on the right-hand side of FIG. 6, the glue printer 608 may comprise several rows of glue nozzles 665 which are arranged in parallel and the direction of which is oriented perpendicular to the direction of movement of the label 607 and tangentially to the contacting surface of the vacuum pallet 604. The glue nozzles may here also be configured as glue channels in an end face of the glue printer. The right-hand side of the figure shows a front view of the nozzle array of the glue printer 608, whereas on the left-hand side of the figure a front view of the vacuum pallet 604 is shown.

The front view of the glue printer 608 shows a plurality of glue nozzles 665, which, according to the depicted, non-limiting further development, are arranged in three parallel rows. For increasing the resolution of the printed glue image, the rows may be “staggered” relative to one another, in that the glue nozzles of the central row are positioned in a vertical direction between the glue nozzles of the respective neighboring rows. In the present figure, the glue nozzles 665b required for applying glue to the exemplarily indicated shoulder label 607 are shown in a filled condition, whereas the non-required glue nozzles 665a are shown in an open condition. While the vacuum pallet 604 is passing by, the respective required glue nozzles 665b are activated in a controlled manner such that glue will be applied only to the glue application surface of the shoulder label 607, but not to the non-occupied contacting surface of the vacuum pallet. Depending on the dimensions of the nozzle array in the vertical direction, labels of an almost arbitrary size and shape can be coated with glue in this way.

The vacuum pallet 604 shown in the left-hand part of FIG. 6 comprises, according to the present further development, a plurality of suction openings 646, which are arranged in the form of a matrix and which may optionally be configured as suction cups. As has already been mentioned, control valves may be provided in the supply channels of the suction openings, the suction openings being adapted to be activated and deactivated individually or in groups by means of these control valves. It follows that only the activated suction openings have a negative pressure applied thereto during operation. In the present figure, the activated suction openings 646b are shown in a filled condition, whereas the deactivated suction openings 646a are shown in an open condition. The activation pattern shown corresponds here to the shape of the outlined shoulder label 607. By controlling the control valves via an open-loop and/or closed-loop control unit 140 of the labeler, labels of an almost arbitrary shape can thus reliably be conveyed on the contacting surface of the vacuum pallet 604, without any unnecessary vacuum output being required. The respective activation patterns may here be stored together with the respective glue image or images in a memory unit of the open-loop and/or closed-loop control unit after the fashion of a type management.

FIG. 7a-f show exemplary label formats and glue images, which can be processed making use of the further developments described. FIG. 7a shows a shoulder label with horizontally applied glue strips 775. For a reliable hold on a container to be labeled, a strip width of 1 mm and a strip thickness of 50 μm will suffice. The glue nozzles of two neighboring rows shown in FIG. 6 may e.g. be spaced apart at a vertical distance of 3.5 mm, so that glue strips spaced apart at a distance of 3.5 mm can be applied. In this way, also irregular label formats, like the shoulder label in FIG. 7a or the champagne band in FIG. 7b, can be coated with glue up to the edge.

FIG. 7c shows a wrap-around label which has had applied thereto a leading-edge glue coat 776a, a middle glue coat 77d, a trailing-edge glue coat 776b and two central safety strips 776e. It can clearly be seen how the amount of glue used can be reduced substantially by means of the glue printer. In addition, as regards the trailing-edge glue coat 776b, one corner 776c, which may e.g. be used as an engagement point for removing the label, may intentionally be left blank.

Finally, FIG. 7d-f show labels with more complex glue images. In FIG. 7d an area in the form of a logo was left blank, whereas the labels according to FIGS. 7e and 7f have had printed thereon a rectangular glue pattern 778 and a round glue pattern 779, respectively.

The labelers described allow cold glue to be directly applied, in the form of almost arbitrary glue images, to glue application surfaces of labels of an almost arbitrary shape and size. In addition, due to direct glue application, the glue-coated labels can be placed directly by the pallets onto the containers to be labeled. A gripper cylinder, which would otherwise be necessary, is thus no longer required. Moreover, the use of the ink-jet method for applying glue to the labels allows a precise and economical glue application, whereby resources and costs will be saved.

1. A method for preparing labels for application to containers, comprising:
applying glue in a variable glue image directly onto a glue application surface of at least one label via a controllable glue printer.

2. The method according to claim 1, further comprising individual or groupwise control of a plurality of glue nozzles of the glue printer in such a way that a desired glue image is applied to the glue application surface of the label.

3. The method according to claim 1, further comprising the step of moving the glue application surface to be printed-on past a plurality of glue discharge openings of the glue printer by means of a controllably pivotable pallet, with the glue application surface facing away from the pallet.

4. The method according to claim 3, wherein the pallet is pivoted such that the glue application surface to be printed-on is moved past the glue discharge openings of the glue printer at a constant distance therefrom, in particular a distance between 1 mm and 2.5 mm.

5. The method according to claim 3, further comprising the step of suctionally attracting the label by means of a plurality of suction openings in a contacting surface of the pallet.

6. The method according to claim 5, wherein the suction openings are activated or deactivated, individually or in groups, depending on a size and/or shape of the label to be conveyed.

7. The method according to claim 5, further comprising the step of releasing the label by deactivating all the suction openings of the pallet.

8. An apparatus for preparing labels for application to containers, comprising:
a conveying unit for labels; and
a controllable glue printer;
wherein the conveying unit and the glue printer are configured such that, via the glue printer, glue can be applied in a variable glue image directly onto a glue application surface of at least one label conveyed by the conveying unit.

9. The apparatus according to claim 8, wherein the glue printer comprises a plurality of glue nozzles controllable individually or in groups.

10. The apparatus according to claim 9, wherein the plurality of controllable glue nozzles is arranged in one or several rows which are parallel to one another.

11. The apparatus according to claim 8, wherein the conveying unit comprises a pallet carousel with a plurality of pallets, which are adapted to be driven such that they circulate around an axis of rotation.

12. The apparatus according to claim 11, further comprising a negative pressure supply unit, and where each pallet is configured as a vacuum pallet with a plurality of suction openings on a contacting surface of the pallet for the labels to be conveyed.

13. The apparatus according to claim 12, wherein the pallet is configured such that the suction openings are supplied with negative pressure individually or in groups.

14. The apparatus according to claim 9, further comprising an open-loop and/or closed-loop control unit configured for controlling the negative pressure supply of the suction openings and/or the activation of the glue nozzles depending on a shape and/or size of the labels.

15. The apparatus according to claim 8, further comprising a controllable deformation unit for removing glue from a deformable reservoir by deforming the reservoir.

16. The apparatus according to claim 9, wherein the glue nozzles are controllable individually or in groups according to an ink-jet head principle.

17. The apparatus according to claim 10, and wherein the plurality of controllable glue nozzles are displaced relative to one another in a longitudinal direction.

18. The apparatus of claim 11, wherein the plurality of pallets are pivotable about pivot axles displaced relative to the axis of rotation.

19. The apparatus according to claim 12, wherein the negative pressure supply unit is a vacuum pump.
